(19) United States
(12) Patent Application Publication
(10) Pub. No.: US 2018/0253677 A1
(43) Pub. Date: Sep. 6, 2018

(54) Method for Performing Dynamic Data Analytics

(71) Applicant: Gregory James Foster, Huntington Beach, CA (US)

(72) Inventor: Gregory James Foster, Huntington Beach, CA (US)

(21) Appl. No.: 15/909,953

(22) Filed: Mar. 1, 2018

Related U.S. Application Data
(60) Provisional application No. 62/465,263, filed on Mar. 1, 2017.

(51) Int. Cl. G06Q 10/06; G06F 15/18; H04L 29/08

(52) U.S. Cl. CPC G06Q 10/06393; H04L 67/306; G06F 15/18

(57) ABSTRACT

A method for performing dynamic data analytics includes a user account that is managed by a remote server and task profiles that are associated to key performance indicators (KPI). The user account is associated to a PC device and enables a user to interact with the system. The task profile is a digital characterization of the system being monitored and KPIs denote the variables which track the system's performance. The method begins by prompting the user to select a desired task profile that characterizes the system. The method then gathers initial datasets from external sources and corelates these datasets to corresponding KPIs. The method continues by receiving and tracking subsequent datasets in order to create a real-time summarization report of the system data. Once the summarization report is created the method outputs an interactive representation of the data that the user manipulates to achieve a granular understanding of the system.

The current application claims a priority to the U.S. Provisional Patent application Ser. No. 62/465,263 filed on Mar. 1, 2017.

### FIELD OF THE INVENTION

The present invention relates generally to a data analytics method. More specifically, the present invention relates to a method for analyzing longitudinal datasets in order to predict how to maximize the performance of a system being monitored.

### BACKGROUND OF THE INVENTION

Traditional data analytics systems provide powerful tools for visualizing and interpreting data. These systems enable a user to make sense of inordinately large datasets. Additionally, coupled with machine learning techniques, these systems can function as predictive analytics systems that provide the user with information about the future state of a system being analyzed. While traditional data analytics systems provide the user with added value, these systems are frequently designed for discrete purposes. Thus, these systems can only be used to analyze a narrow range of datasets. Because of this limitation, it is difficult for traditional data analytics systems to provide a holistic summary of a system that includes disparate datasets.

The method of the present invention addresses these shortcomings by providing a general-purpose analytics platform that can be used to accurately characterize a system's past, present, and future states. To achieve this, the method of the present invention employs a dynamic analysis routine that can be tailored to the needs of disparate systems. The method of the present invention enables the user to enter the type of system that is being analyzed. Further, the method of the present invention enables the user to specify the variables which must be monitored in order to track the overall performance of the system being monitored. This enables the method of the present invention to monitor a system over an extended period of time. In addition to the user-specified analysis variables, the method of the present invention employs machine learning processes to identify new and improved metrics for system performance characterization. This characterization data is presented to the user in an interactive dashboard that enables the user to perform granular analysis and modification of the system being monitored.

### BRIEF DESCRIPTION OF THE DRAWINGS

FIG. 1 is block diagram illustrating a system overview of the present invention.

FIG. 2 is a flowchart illustrating the overall method of the present invention.

FIG. 3 is a flowchart illustrating the steps required to enter a new KPI using the method of the present invention.

FIG. 4 is a flowchart illustrating the steps required to enter a new task profile using the method of the present invention.

FIG. 5 is a flowchart illustrating the steps required to associate each initial raw dataset with at least one corresponding KPI using the method of the present invention.

FIG. 6 is a flowchart illustrating the steps for employing a machine learning process to identify a new KPI using the method of the present invention.

FIG. 7 is a flowchart illustrating the steps for employing a machine learning process to generate data-specific alerts using the method of the present invention.

FIG. 8 is a flowchart illustrating the steps required to create the summarization report using the method of the present invention.

FIG. 9 is a flowchart illustrating the steps required to incorporate the trend prediction into the summarization template using the method of the present invention.

FIG. 10 is a flowchart illustrating the steps required to drill down into the summarization report using the method of the present invention.

### DETAIL DESCRIPTIONS OF THE INVENTION

All illustrations of the drawings are for the purpose of describing selected versions of the present invention and are not intended to limit the scope of the present invention.

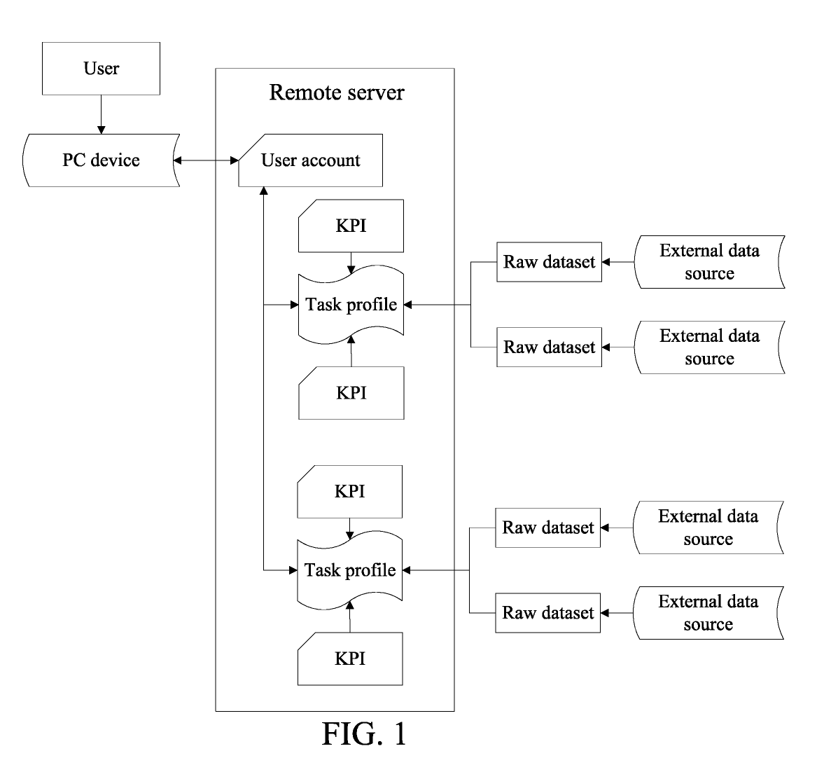

Referring to FIG. 1 through FIG. 10, the preferred embodiment of the present invention, the method for performing dynamic data analytics, is a method for identifying and tracking key performance indicators (KPI) for systems that generate multivariate datasets. In addition to tracking, the present invention provides a method for performing predictive analytics that enables a user to accurately gauge how modifying specific variables will affect one or more KPIs. Further, the method of the present invention is used gather datasets from multiple external sources and then correlate said datasets to the KPIs. It is an aim of the method of the present invention to provide an analytics platform that uses both user input and machine learning techniques to identify KPIs. As a result, the method of the present invention is able to provide the user with a comprehensive analysis of how one or more variables affect the performance of the system being analyzed. Further, the method of the present invention is able to provide the user with detailed summaries of both historic and predicted system performance. This enables the user to analyze how individual variables will affect system performance.

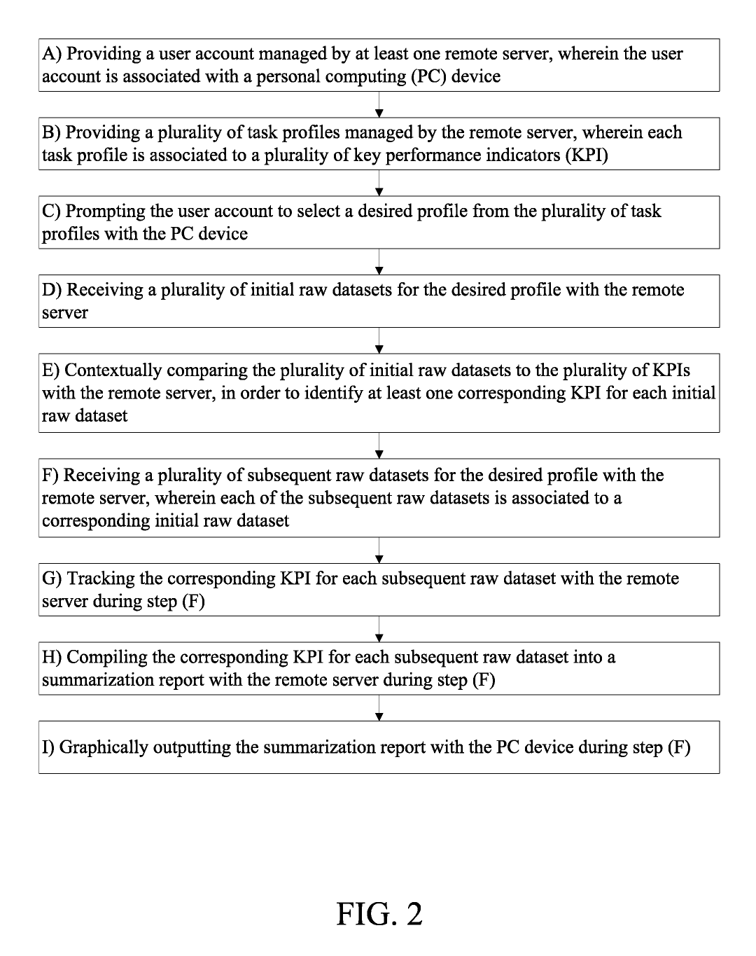

Referring to FIG. 1 and FIG. 2, to achieve the above-described functionality, the system used to execute the method of the present invention provides a user account managed by at least one remote server (Step A). The remote server is used to perform background processes such as data acquisition and analysis. Additionally, the remote server communicates data with the PC device. The PC device is any computing device capable of executing the method of the present invention. Specifically, remote computer may define devices that include, but are not limited to, laptop computers, smartphones, tablet computers, and desktop computers. Alternatively, the system used to execute the present invention may utilize a blockchain architecture, where a distributed network of computing devices takes the place of the remote server. This enables the system used to execute the method of the present invention to operate in a secure manner that optimizes computational efficiency as well as data storage and retrieval speed. The user account is a digital record of the user and contains the credentials required to access and manipulate the data gathered by the method of the present invention. Further, the system used to execute the method of the present invention provides a plurality of task profiles managed by the remote server (Step B). Each task profile contains a description of a specific task or system that the method of the present invention is being used to analyze. Specifically, each task profile is associated to a plurality of KPIs. consequently, the method of the present invention can be used to analyze the datasets from disparate system once the user has properly characterized the system by outlining the pertinent KPIs and system variables.

Referring to FIG. 1 and FIG. 2, the overall method of the present invention is used to gather datasets, analyze the datasets, and provide the user with the results of said analysis. To accomplish this, the overall method of the present invention begins by prompting the user account to select a desired profile from the plurality of task profiles with the PC device (Step C). This step enables the user to characterize the system that the method of the present invention will be used to analyze. The user is given the option to create a new task profile and input completely new KPIs or to select a task profile from a list of saved task profiles. Preferably, the remote server saves task profiles so that the user does not have to recharacterize a system multiple times. Additionally, the method of the present invention may employ a machine learning routine to automatically characterize a system based on the datasets provided by similar systems that were previously analyzed. The overall method of the present invention continues by receiving a plurality of initial raw datasets for the desired profile with the remote server (Step D). The plurality of initial raw datasets comprises a collection of the baseline data that is provided by the system being analyzed. The method of the present invention is designed to aggregate data from external sources that include, but are not limited to sensor arrays, third party databases, and user input. The overall method of the present invention continues by contextually comparing the plurality of initial raw datasets to the plurality of KPIs with the remote server, in order to identify at least one corresponding KPI for each initial raw dataset (Step E). This step is used to validate and organize raw data that is provided to the remote server. For example, if the method of the present invention is used to analyze a clinical trial the initial raw datasets may include datasets that are associated with patient participation, drug efficacy, and administrative expenditures. Each of these datasets will be analyzed to determine the at least one KPI for which the dataset provides relevant information. Once the corresponding KPI is identified, the dataset will be included in the variables that are used to track and analyze the corresponding KPI. The overall method of the present invention continues by receiving a plurality of subsequent raw datasets for the desired profile with the remote server (Step F). Each of the subsequent raw datasets is associated to a corresponding initial raw dataset. Further, each of the subsequent raw datasets includes the data that is provided to the remote server over a period of time. This enables the method of the present invention to perform longitudinal analysis of the system. Additionally, the system used to execute the method of the present invention may receive subsequent raw datasets from a distributed network of internet of things (IoT) devices. These devices may provide sensor data as well as generate alarms when measured variables cross predetermined thresholds.

Referring to FIG. 1 and FIG. 2, once the datasets have been characterized and the longitudinal data becomes available, the method of the present invention can be employed to provide the user with on-demand information and analysis. Accordingly, the overall method of the present invention continues to receive subsequent raw data until the user decides to terminate the system analysis. The overall method of the present invention continues by tracking the corresponding KPI for each subsequent raw dataset with the remote server during Step F (Step G). The method of the present invention performs real-time tracking and data analysis. Thus, Step G is used to constantly update the data that the method of the present invention is used to store and present to the user. Further, the overall method of the present invention employs a machine learning routine to analyze the subsequent raw datasets and identify new KPIs that the user has not specified. The overall method of the present invention continues by compiling the corresponding KPI for each subsequent raw dataset into a summarization report with the remote server during Step F (Step H). Step H is used to perform real-time analysis of the subsequent raw data. Specifically, Step H is used to create a summarization report that contains statistical analysis of the system as well as predictive analytics that inform the user of future system performance. The overall method of the present invention continues by graphically outputting the summarization report with the PC device during Step F (Step I). As described above, the method of the present invention is designed to generate real-time analysis of the datasets and to provide the user with pertinent information regarding the system being analyzed. Accordingly, Step I provides the user with a graphical representation of the ongoing data analysis. Further, the method of the present invention enables the user to view highly granular data that relates to one or more variables within a dataset. Further, the graphical representation of the data provides the user with the ability to perform experimental analysis that simulates how the system will respond to changing one or more variables. This functionality enables the user to fine tune the system being analyzed to achieve a desired outcome.

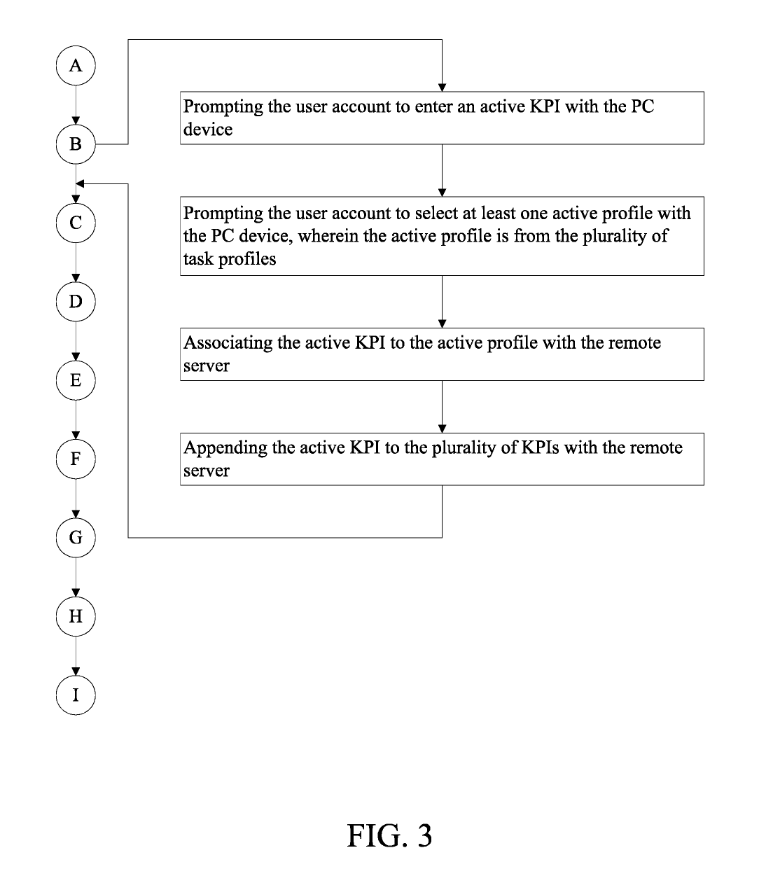

Referring to FIG. 3, the method of the present invention is designed to give the user dynamic and granular control over how the provided raw datasets are analyzed. To accomplish this, the method of the present invention includes sub-processes that enable the user to create new KPIs. Specifically, the method of the present invention includes a sub-process that enables the user to create new KPIs for systems that are currently being analyzed as well as systems with data that has not been provided to the remote server.

This sub-process begins by prompting the user account to enter an active KPI with the PC device. The Active KPI is a KPI that the user is actively providing to the remote server. This enables the user to define new KPIs that the method of the present invention will be able to track and analyze. The sub-process continues by prompting the user account to select at least one active profile with the PC device. Similar to the active KPI, the active profile is a task profile that the user is actively modifying. Accordingly, the user is able to choose the task profile for which the active KPI will be used as a measure for data analysis. The sub-process continues by associating the active KPI to the active profile with the remote server. Further, the sub-process continues by appending the active KPI to the plurality of KPIs with the remote server. Once the user has entered the active KPI and defined the task profile for which the active KPI is relevant, the remote server creates a record of the active KPI and designates the active KPI as a variable of the system being analyzed using the method of the present invention. As previously described, the sub-process enables the user to add KPIs to the task profile of a system that is currently being analyzed. For example, if the user becomes aware of a new KPI halfway through a clinical trial, the user does not have to recharacterize the entire system. The user is able to simply add an active KPI to the active task profile and the method of the present invention will include the active KPI in any analysis performed thereafter.

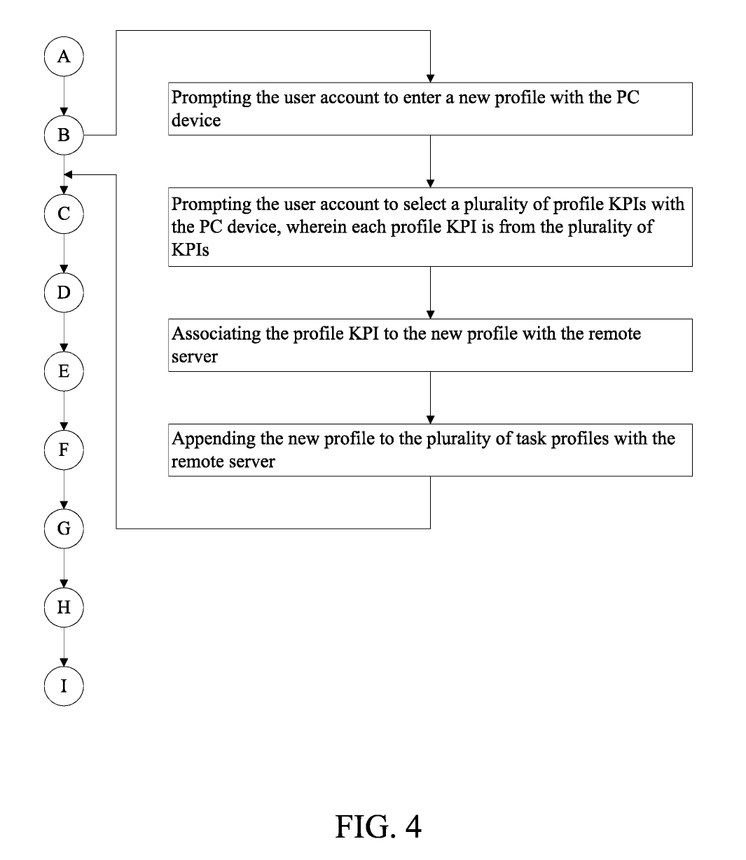

Referring to FIG. 4, the method of the present invention is designed to analyze a host of varying systems and datasets. To accomplish this, the method of the present invention includes sub-processes that enable the user to create new task profiles. Specifically, the method of the present invention includes a sub-process that enables the user to characterize a new system to be analyzed by defining the desired analysis and the type of datasets that will be provided to the remote server. This sub-process begins by prompting the user account to enter a new profile with the PC device. In this step the user is invited to provide a characterization of the system and datasets that will be analyzed by the method of the present invention. For example, if the user is analyzing a clinical trial, the task profile will specify that the provided raw datasets will include patient response data, drug efficacy data, and administrative expenditure data. The sub-process continues by prompting the user account to select a plurality of profile KPIs with the PC device. Once the datasets for the system have been described, the user is then prompted to select the KPIs that will be used to analyze the system. Because, each task profile can include multiple KPIs the method of the present invention can be used to analyze multiple aspects of a single system. As can be seen in the clinical trials example, the method of the present invention can be used to analyze various aspects of a system, concurrently. The sub-process continues by associating the profile KPI to the new profile with the remote server. Further, the sub-process continues by appending the new profile to the plurality of task profiles with the remote server. Once the user has entered the new task profile and selected the appropriate profile KPIs, the remote server creates a record of the new task profile and designates the profile KPIs as variables of the system being analyzed using the method of the present invention.

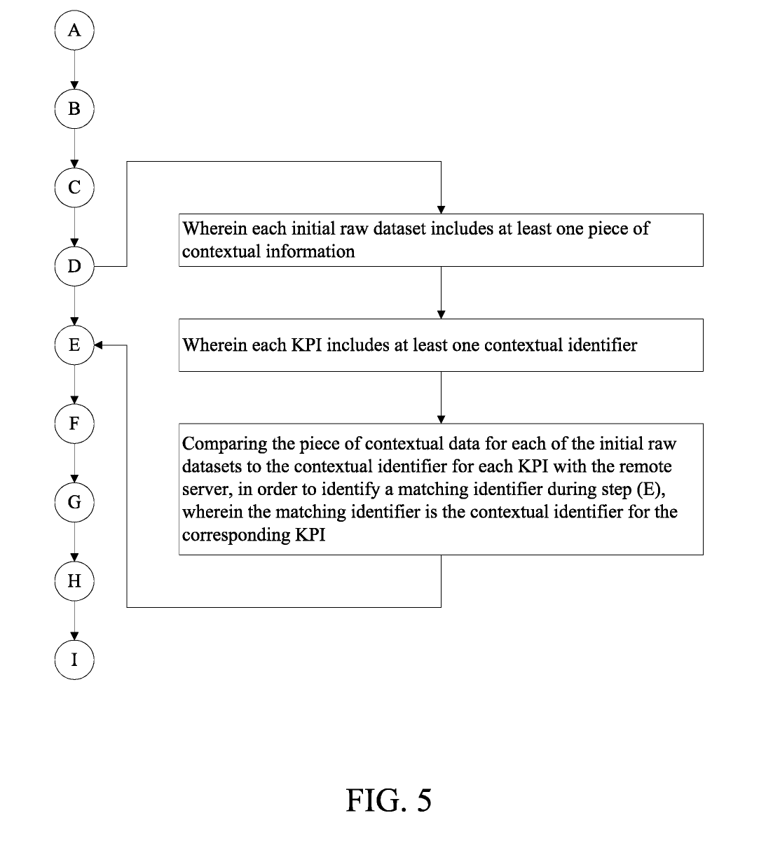

Referring to FIG. 5, although the user has characterized the system, the raw datasets that are provided to the remote server must be validated and organized before analysis can begin. To accomplish this the present invention includes a sub-process that assigns each raw dataset to a pertinent KPI based on contextual information that is included in the raw dataset. Specifically, each initial raw dataset includes at least one piece of contextual information. The piece of contextual information is an identifier that is used to determine the type of data that is included in a raw dataset. This information can include, but is not limited to, metadata, file identifiers, and the actual content of the dataset. Similarly, each KPI includes at least one contextual identifier. The contextual identifier is used to define the types of datasets that can be used to track and analyze the each KPI. The sub-process continues by comparing the piece of contextual data for each of the initial raw datasets to the contextual identifier for each KPI with the remote server, in order to identify a matching identifier during Step E. Specifically, the matching identifier is the contextual identifier for the corresponding KPI. Accordingly, the sub-process is able to parse the raw datasets and determine how to appropriate distribute incoming information. This enables the system to automatically include new raw datasets in the calculations required to monitor the corresponding KPI. Alternatively, if a raw dataset does not include a piece of contextual information, the remote server can alert the user that the raw dataset cannot be included in the system analysis. This enables the user to perform error remediation while validating the datasets that are provided by the system being analyzed.

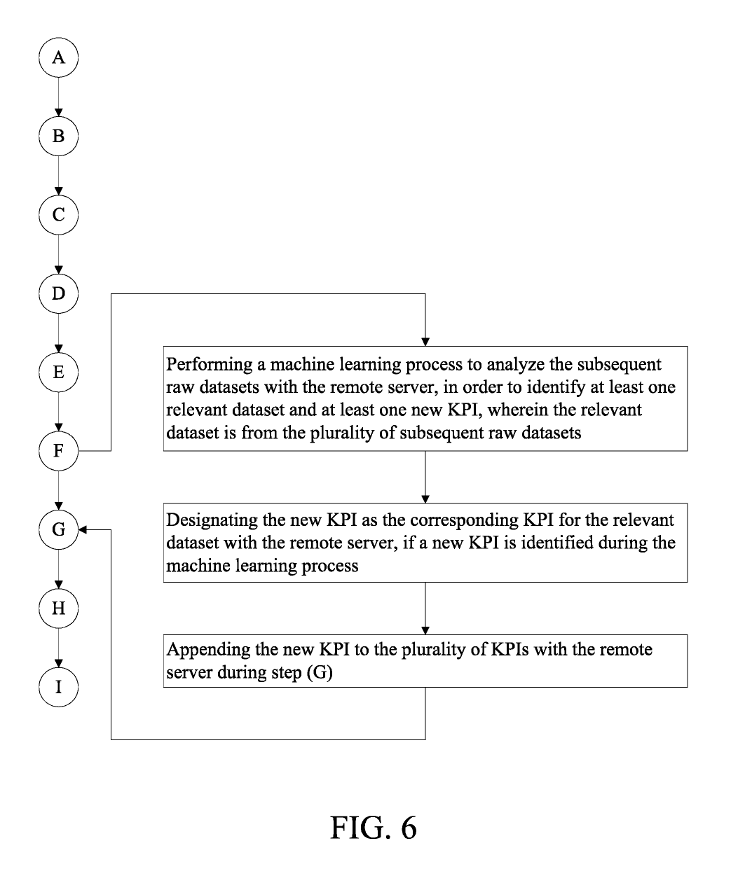

Referring to FIG. 6, the method of the present invention is designed to augment the user's analysis capabilities with a sub-process that employs a machine learning based analysis of the provided raw datasets. This sub-process begins by performing a machine learning process to analyze the subsequent raw datasets with the remote server, in order to identify at least one relevant dataset and at least one new KPI. The machine learning process is a routine that makes use of artificial intelligence to analyze the subsequent raw datasets that are provided to the remote server over a period of time. This routine uses the initial raw datasets, the subsequent raw datasets, and the KPIs as training information. The relevant dataset is a raw dataset that the machine learning process determines to be a useful factor in determining the performance of the system being analyzed. Similarly, the new KPI is a KPI that the machine learning process has identified as an important marker of system performance. It is an aim of the present invention to provide a machine learning process that continually performs analysis of the subsequent raw datasets. Additionally, the machine learning process uses any information provided to the remote server as training data to further refine a model of the system being analyzed. Once the machine-learning process has identified the relevant datasets and the new KPIs, the sub-process continues by designating the new KPI as the corresponding KPI for the relevant dataset with the remote server, if a new KPI is identified during the machine learning process. Further, the sub-process continues by appending the new KPI to the plurality of KPIs with the remote server during Step G. As a result, the relevant datasets are associated to the new KPI and the method of the present invention will include the new KPI as one of the measures of system performance.

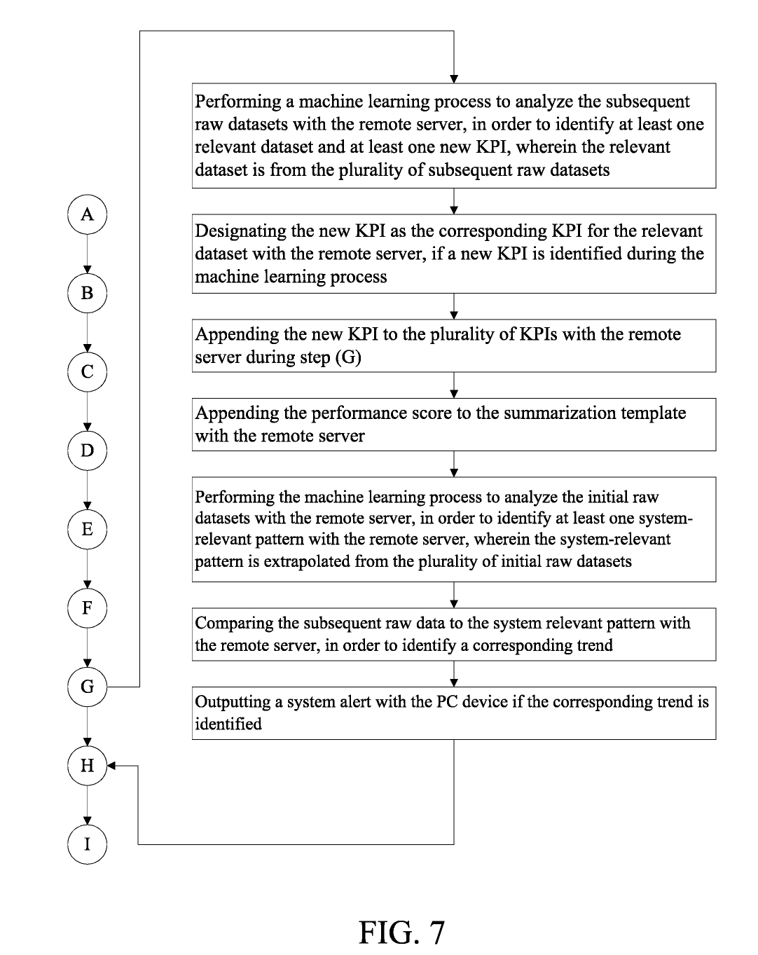

Referring to FIG. 7, the method of the present invention is designed to analyze the subsequent raw datasets in relation to previously acquired datasets in order to identify when the system being analyzed is operating in a manner similar to a historically identified pattern. This enables the method of the present invention to generate alerts when the subsequent raw datasets indicate that the overall system performance will likely drop below a predefined threshold. To accomplish this, the method of the present invention includes a sub-process that employs the machine learning process to analyze the initial raw data. Specifically, the sub-process begins by performing the machine learning process to analyze the initial raw datasets with the remote server, in order to identify at least one system-relevant pattern with the remote server. The system-relevant pattern is a trend in the machine learning process extrapolates from the initial data. Additionally, the user can specify the types of data trends that the machine learning process will identify as the system-relevant pattern. For example, the user may specify that a rapid decline in the number of patients participating in a clinical trial is a system-relevant trend that has been identified in the past. This rapid decline has been shown to be a precursor to the clinical trial shutting down. The sub-process continues by comparing the subsequent raw data to the system relevant pattern with the remote server, in order to identify a corresponding trend. The corresponding trend is collection of data points that are included in the subsequent data which mimic the data trend identified by the system-relevant pattern. Continuing the example of clinical trials, when subsequent raw data indicates a rapid decline in patient participation, the sub-process will identify the rapid decline as the corresponding trend. The sub-process continues by outputting a system alert with the PC device if the corresponding trend is identified. This step enables the user to act accordingly in an effort to prevent the system being analyzed from achieving an unwanted future state. Preferably, the system alert contains recommendations for how the user should modify the system variables in order to steer the system toward a desirable outcome.

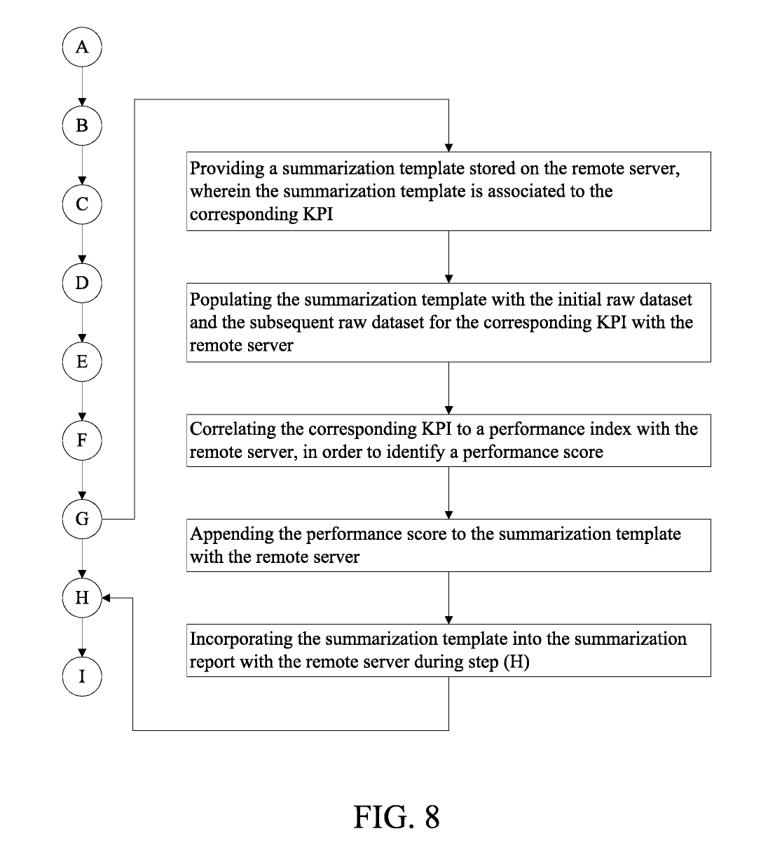

Referring to FIG. 8, the method of the present invention is designed to summarize the information that is included in the raw datasets to give the user an understanding of the system's performance. To accomplish this the present invention provides a summarization template for each KPI that is stored on the remote server. The summarization template is a template that identifies the pieces of information that are pertinent to the analyzing each KPI. The sub-process begins by populating the summarization template with the initial raw dataset and the subsequent raw dataset for the corresponding KPI with the remote server. The sub-process pulls required information out of the initial raw dataset and the subsequent raw dataset and uses this information to populate data fields in the summarization template for the KPI to which the raw datasets are associated. The sub-process continues by correlating the corresponding KPI to a performance index with the remote server, in order to identify a performance score. The performance index is a user-defined metric that can be used to determine the performance of the system with respect to one or more KPIs. The method of the present invention provides a performance index that includes a weighted qualitative metric and a weighted quantitative metric that are used to analyze the corresponding KPI. The weighted quantitative metric is a user-specified value that enables the method of the present invention to perform statistical analysis of the corresponding KPI in order to arrive at a normalized score of quantitative performance. Similarly, the weighted qualitative metric is a user-specified value that enables the method of the present invention to perform statistical analysis of the corresponding KPI in order to arrive at a normalized score of qualitative performance. Relatedly, the performance score is a holistic measure of how well the system that is being analyzed is performing with respect to a single KPI. The performance score is determined by performing a statistical analysis of the KPI with respect to the desired performance of the system. Specifically, the performance score is a normalized rating that incorporates the normalized score of quantitative performance and the normalized score of qualitative performance into a score that analyzes the overall performance of the system being analyzed. The sub-process continues by appending the performance score to the summarization template with the remote server. Accordingly, the summarization template is able to provide a comprehensive summary of the data that is pertinent to each KPI. The sub-process continues by incorporating the summarization template into the summarization report with the remote server during Step H. The summarization report is a formatted report that contains the information that can be used to measure and quantify system performance. As such, the summarization template for each of the KPIs is incorporated into the summarization report. Preferably, the user is able to specify both the quantitative metric and the qualitative metric when characterizing the KPI or task profile.

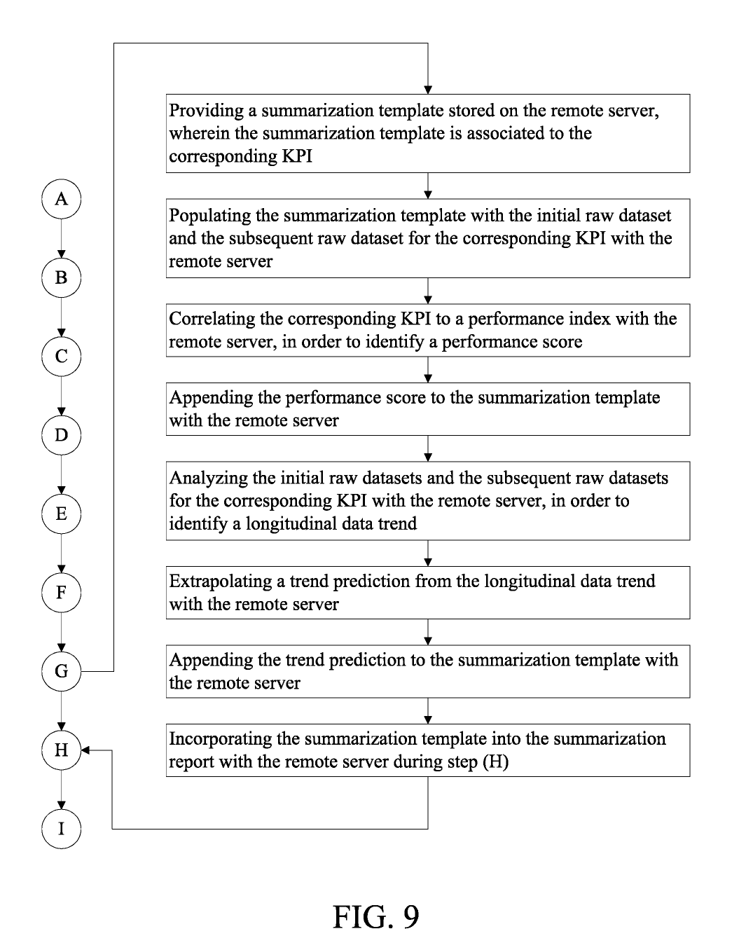

Referring to FIG. 9, in addition to performing real time analysis of historically provided data, the method of the present invention includes a sub-process for performing predictive analytics. This enables the method of the present invention to predict how the system will perform at a user-specified point in the future. This sub-process begins by analyzing the initial raw datasets and the subsequent raw datasets for the corresponding KPI with the remote server, in order to identify a longitudinal data trend. The longitudinal data trend is a representation of how the system has performed in the past. The sub-process continues by extrapolating a trend prediction from the longitudinal data trend with the remote server. The trend prediction is an analysis that indicates how the system is likely to perform given the current datasets. Additionally, the method of the present invention can use the machine learning process to create more accurate predictions of the future state of the system being analyzed. The sub-process continues by appending the trend prediction to the summarization template with the remote server. The sub-process includes the trend prediction in the summarization template, so that the user is able to view the past, present, and predicted future state of the system being analyzed.

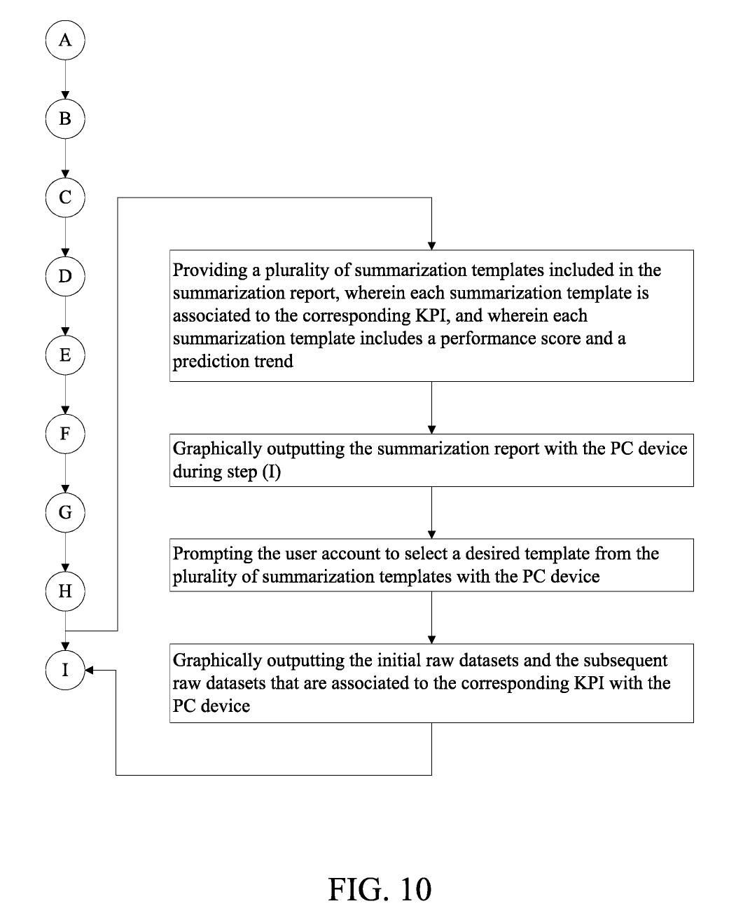

Referring to FIG. 10, the method of the present invention is designed to enable the user to perform granular data analysis of the variables that affect the KPIs. Specifically, the method of the present invention includes a sub process that enables the user to drill down into the data that is provided in the summarization report. This sub-process begins by graphically outputting the summarization report with the PC device during Step I. The user is presented with a graphical interface that functions as a data visualization dashboard. This graphical interface is an interactive representation of each summarization template for the plurality of KPIs. The summarization templates provide a high-level view of the overall system performance as it relates to the KPIs. The sub-process continues by prompting the user account to select a desired template from the plurality of summarization templates with the PC device. The user is given the option to focus on a single summarization template rather than viewing the high-lever system overview. Once the user selects the desired template, the graphical interface is refreshed, and the user is presented with data that is pertinent to the desired summarization template. The user can get a more focused view of the data included in summarization template by selecting specific variables. This functionality is repeated, such that the user is able to focus on individual pieces of data that are included in the datasets. Accordingly, the method of the present invention provides the user with an ability to execute granular analysis and visualization of the data included in the datasets. Preferably, the summarization report is formatted as a multilayered interface where summarization templates that relate to KPIs which represent high-level data analysis are stacked on top of summarization templates that relate to KPIs which represent increasingly specific analysis. Furthering the clinical trials example, the highest-level summarization template may relate to total expenditures.

This template may be populated with values that summarize various lower level KPIs such as administrative, clinical, and operational expenses. If the user would like to view more information about administrative expenses, the user selects the administrative expenses value. The method of the present invention then presents the user with the summarization template that contains only information that relates to the administrative expenses KPI. Likewise, the administrative expenses KPI summarization template may be populated with values that summarize various lower level KPIs such as the salaries for clinicians, nurses, and researchers. The user can then select a desired value and the method of the present invention will present the corresponding summarization template. As described above, each summarization template includes a performance score. This enables the user to identify the specific variables that are performing poorly. Additionally, the user can identify specific lower level KPIs that act as the canary in the coalmine for predicting changes in the overall system performance.

Although the invention has been explained in relation to its preferred embodiment, it is to be understood that many other possible modifications and variations can be made without departing from the spirit and scope of the invention as hereinafter claimed.

What is claimed is:

1. A method for performing dynamic data analytics, the method comprises the steps of:
(A) providing a user account managed by at least one remote server, wherein the user account is associated with a personal computing (PC) device;
(B) providing a plurality of task profiles managed by the remote server, wherein each task profile is associated to a plurality of key performance indicators (KPI);
(C) prompting the user account to select a desired profile from the plurality of task profiles with the PC device;
(D) receiving a plurality of initial raw datasets for the desired profile with the remote server;
(E) contextually comparing the plurality of initial raw datasets to the plurality of KPIs with the remote server, in order to identify at least one corresponding KPI for each initial raw dataset;
(F) receiving a plurality of subsequent raw datasets for the desired profile with the remote server, wherein each of the subsequent raw datasets is associated to a corresponding initial raw dataset;
(G) tracking the corresponding KPI for each subsequent raw dataset with the remote server during step (F);
(H) compiling the corresponding KPI for each subsequent raw dataset into a summarization report with the remote server during step (F);
(I) graphically outputting the summarization report with the PC device during step (F);

2. The method for performing dynamic data analytics, the method as claimed in claim 1 comprises the steps of:
prompting the user account to enter an active KPI with the PC device;
prompting the user account to select at least one active profile with the PC device, wherein the active profile is from the plurality of task profiles;
associating the active KPI to the active profile with the remote server;
appending the active KPI to the plurality of KPIs with the remote server;

3. The method for performing dynamic data analytics, the method as claimed in claim 1 comprises the steps of:
prompting the user account to enter a new profile with the PC device;
prompting the user account to select a plurality of profile KPIs with the PC device, wherein the profile KPI is from the plurality of KPIs;
associating the profile KPI to the new profile with the remote server;
appending the new profile to the plurality of task profiles with the remote server;

4. The method for performing dynamic data analytics, the method as claimed in claim 1 comprises the steps of:
wherein each initial raw dataset includes at least one piece of contextual information;
wherein each KPI includes at least one contextual identifier;
comparing the piece of contextual data for each of the initial raw datasets to the contextual identifier for each KPI with the remote server, in order to identify a matching identifier during step (E), wherein the matching identifier is the contextual identifier for the corresponding KPI;

5. The method for performing dynamic data analytics, the method as claimed in claim 1 comprises the steps of:
performing a machine learning process to analyze the subsequent raw datasets with the remote server, in order to identify at least one relevant dataset and at least one new KPI, wherein the relevant dataset is from the plurality of subsequent raw datasets;
designating the new KPI as the corresponding KPI for the relevant dataset with the remote server, if a new KPI is identified during the machine learning process;
appending the new KPI to the plurality of KPIs with the remote server during step (G);

6. The method for performing dynamic data analytics, the method as claimed in claim 5 comprises the steps of:
performing the machine learning process to analyze the initial raw datasets with the remote server, in order to identify at least one system-relevant pattern with the remote server, wherein the system-relevant pattern is extrapolated from the plurality of initial raw datasets;
comparing the subsequent raw data to the system relevant pattern with the remote server, in order to identify a corresponding trend;
outputting a system alert with the PC device if the corresponding trend is identified;

7. The method for performing dynamic data analytics, the method as claimed in claim 1 comprises the steps of:
providing a summarization template stored on the remote server, wherein the summarization template is associated to the corresponding KPI;
populating the summarization template with the initial raw dataset and the subsequent raw dataset for the corresponding KPI with the remote server;
correlating the corresponding KPI to a performance index with the remote server, in order to identify a performance score;
appending the performance score to the summarization template with the remote server;
incorporating the summarization template into the summarization report with the remote server during step (H);

8. The method for performing dynamic data analytics, the method as claimed in claim 7 comprises the steps of:
analyzing the initial raw datasets and the subsequent raw datasets for the corresponding KPI with the remote server, in order to identify a longitudinal data trend;
extrapolating a trend prediction from the longitudinal data trend with the remote server;
appending the trend prediction to the summarization template with the remote server;

9. The method for performing dynamic data analytics, the method as claimed in claim 1 comprises the steps of:
providing a plurality of summarization templates included in the summarization report, wherein each summarization template is associated to the corresponding KPI, and wherein each summarization template includes a performance score and a prediction trend;
graphically outputting the summarization report with the PC device during step (I);
prompting the user account to select a desired template from the plurality of summarization templates with the PC device;
graphically outputting the desired template with the PC device;
